(19) United States
(12) Patent Application Publication
(10) Pub. No.: US 2018/0056322 A1
(43) Pub. Date: Mar. 1, 2018

(54) System and Apparatus for Dispensing a Heated Personal Lubricant

(71) Applicants: Charles Henri Blanchet, Detroit, MI (US); Christina Stacey, Detroit, MI (US); Ian Cobb, Wixom, MI (US); Grey B. Parker, West Bloomfield, MI (US)

(72) Inventors: Charles Henri Blanchet, Detroit, MI (US); Christina Stacey, Detroit, MI (US); Ian Cobb, Wixom, MI (US); Grey B. Parker, West Bloomfield, MI (US)

(21) Appl. No.: 15/251,956

(22) Filed: Aug. 30, 2016

(51) Int. Cl. B05C 11/10; B05C 5/02; F04B 19/22; F04B 17/03; F04B 49/06; F04B 53/14; H02J 7/02

(52) U.S. Cl. CPC B05C 11/1042; B05C 5/02; F04B 19/22; H02J 50/10; F04B 49/065; F04B 53/14; H02J 7/025; F04B 17/03

(57) ABSTRACT

This invention relates to a system, including an apparatus and method, for dispensing a heated personal lubricant. An enclosure houses all components of the system including a frame member for mounting internal components in a proper geometry; batteries; a disposable cartridge having a canister of personal lubricant; a delivery system including a stepper motor, linear actuator and drive shaft for positively urging a plunger to dispense a small amount of heated oil from the dispenser through a pressure release valve; and printed circuit boards with a microprocessor to control the system.

### BACKGROUND OF THE INVENTION

This application relates to a system and apparatus for dispensing a heated personal lubricant. It is well known that the use of a personal lubricant prior to, in, or after sexual activities may enhance the sexual experience. Further, it is well known that operational difficulties with current dispensers, bottles, tubes, jars, and the like, result in awkward disruption in sexual play, thereby distracting the partners and diminishing the pleasure of such sexual activities. Further yet, when a personal lubricant is heated just prior to application to a partner's sexual parts, the skin is stimulated in a positive manner as opposed to the shock of application of the lubricant at ambient temperature. Application of lubricants at or below ambient temperature may negatively affect the sexual experience. Personal lubricants heated to a temperature equalling or exceeding body temperature results in greater pore penetration and, therefore, less friction and irritation when participating in sexual activities.

There have been numerous and various dispensers for personal lubricants. Some heat the lubricant; some do not heat the lubricant. A recent dispenser is disclosed and described in U.S. Pat. No. 9,233,825 (Madigan). The Madigan dispenser is a complicated mechanism which discharges personal lubricant via gravity feed. Before discharging the contents of the dispenser, a protective seal within the discharge element is ruptured with a piercing element.

U.S. Pat. No. 6,484,514 B1 issued in November of 2002 to Joseph et al., entitled “Product Dispenser Having Internal Temperature Changing Element,” describes a temperature modifying system for heating a product within a flexible container using an exothermic element also contained within the flexible holder. The heat from the exothermic element is released when pressure is applied to the outside of the flexible container causing the internal element to rupture. The product dispensed is heated as a result.

U.S. Pat. No. 6,311,868 B1 issued in November of 2001 to Krietemeier et al., entitled “Dispenser Which Incrementally Heats Fluids with Substantial Non-Volatile Constituent Parts,” describes a device that houses a large quantity of liquid material then transfers a portion of the liquid material to a pre-delivery chamber where it is heated to a desired temperature finally dispensing the liquid material by means of a dispensing spout. The device is AC or DC powered.

U.S. Pat. No. 8,061,918 B2 issued in November of 2011 to Skalitzky et al., entitled “Heated Flowable Dispenser,” describes a portable bottle comprising heat generating means used to heat a portion of personal lubricant contained therein. The bottle comprises a pumping mechanism used to drive the portion of the product to be heated into a heating chamber comprising the bottle. The bottle may be activated when positioned within a docking station which is comprised of the remaining electrical circuitry, including a PCB, and contains or is in communication with a power source.

U.S. Pat. No. 6,454,127 B1 issued in September of 2002 to Suomela et al., entitled “Self-Contained Liquid Dispenser with Heating Means,” describes a portable liquid heating and dispensing system comprising a container housing a main reservoir of liquid a portion of which is heated prior to extraction and a docking station within which the container is positioned providing the electrical power to heat the liquid. A pump assembly is used to lift liquid out of the main reservoir into a chamber of the pump comprising heat generating means and eventually through a spout.

U.S. Patent Application Publication No. 20120125950 A1 published on May 24, 2012 and filed by Bouix et al., entitled “Reusable Pump Dispenser for Heated Personal Care Compositions,” describes a portable hand-held device housing a main reservoir of personal lubricants portion of which is heated prior to extraction. A pump assembly is used to lift the product out of the main reservoir into a chamber of the pump comprising heat generating means and eventually through a spout.

All of the aforementioned prior art involves complex construction which reduces the likelihood of having a simple, stylish outer housing with all operational components within the outer housing. The prior art does not teach or disclose a disposable cartridge retaining a canister of personal lubricant which may be heated and positively dispensed via a delivery mechanism controlled by a microprocessor.

### SUMMARY OF THE INVENTION

The present invention provides a system, including an apparatus and method, for dispensing a heated personal lubricant. A stylish, compact dispensing enclosure has a top plate for lighting and activating the dispensing system via a touch activated printed circuit board (PCB). Thus, the user has a simple, compact dispenser which may be activated with one hand to dispense a personal lubricant in a dark or dimly lit environment without removing cumbersome lids or having to operate an external pumping lever.

The battery operated dispenser may be wirelessly charged through an induction charger antenna disposed within the dispensing enclosure. The batteries are mounted on a frame within the enclosure and provide power to various component PCBs and a stepper motor. Upon activation of the dispenser by touching the logo on the top plate, a capacitance switch triggers a controller which turns on an internal oil heating system to heat the personal lubricant. The light on the top plate blinks indicating that the heating process has been initiated. Once the blinking light changes to a solid light (not blinking), the user is thereby notified that lubricant is heated and ready for dispensing.

The user taps (touches) the logo twice and the pump within the enclosure is activated to dispense one small drop of heated lubricant from the bottom discharge port of the enclosure. The user may continue to double tap the logo and dispense heated lubricant on demand. After a predetermined period of inactivity (range 10-20 minutes) the system powers down. Alternatively, touching the logo for a predetermined, brief period of time (range 3-5 sec.) powers off the system.

The system has a disposable cartridge removably mountable within a cartridge cavity of the frame. The disposable cartridge retains a canister of the personal lubricant, the internal oil heating system, a dispensing plunger and a discharge valve. The cartridge also has a lower cover to retain a canister PCB for controlling the oil heating system.

A stepper motor is also mounted to the frame within the enclosure. The motor operates a linear actuator having a drive shaft attached to a top side of the dispensing plunger within the canister for urging the plunger downwardly through the canister to dispense the heated personal lubricant from the discharge port when the logo is tapped twice.

All of the control of the system is achieved by a main printed circuit within the enclosure powered by the batteries. It includes a microprocessor, a heater controller for controlling the heating coil within the cartridge, a thermistor controller for controlling the thermistor within the cartridge, electrical connectors for the touch PCB, the canister PCB, the battery PCB, the induction charger controller, and the stepper motor controller.

### BRIEF DESCRIPTION OF THE DRAWINGS

The foregoing and further features of the present invention will be apparent from the following description of preferred embodiments which are provided by way of example only in connection with the accompanying figures, of which:

FIG. 1A is a front, top perspective view of the housing of the invention.

FIG. 1B is a rear bottom perspective view of the housing of the invention.

FIG. 1C is front, exploded perspective of the housing of the invention illustrating the top disconnected from the bottom cap showing the disposable cartridge.

FIG. 1D is a cross-sectional view of an assembled dispenser of the present invention.

FIG. 2 is an exploded perspective illustrating various components of the invention.

FIG. 3 illustrates the arrangement of various printed circuit boards (PCBs), the stepper motor, and the induction charging antenna of the present invention.

FIG. 4A is a bottom, side perspective view of the cartridge of the present invention.

FIG. 4B is a cross-sectional view of the cartridge of the present invention.

FIG. 5 illustrates a perspective view of the main body of the present invention which is disposed within the outer housing of the present invention.

FIG. 6 shows the user interface sequence with various components of the present invention.

FIG. 7 illustrates a detailed view of the battery contact connection from the main PCB to the cartridge PCB of A in FIG. 6..

### DETAILED DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

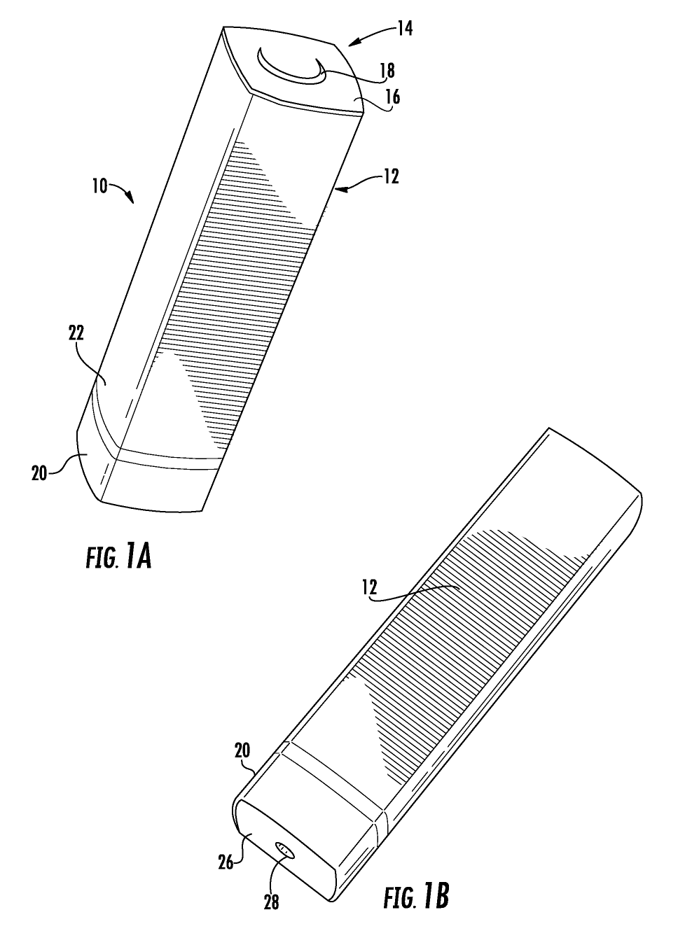

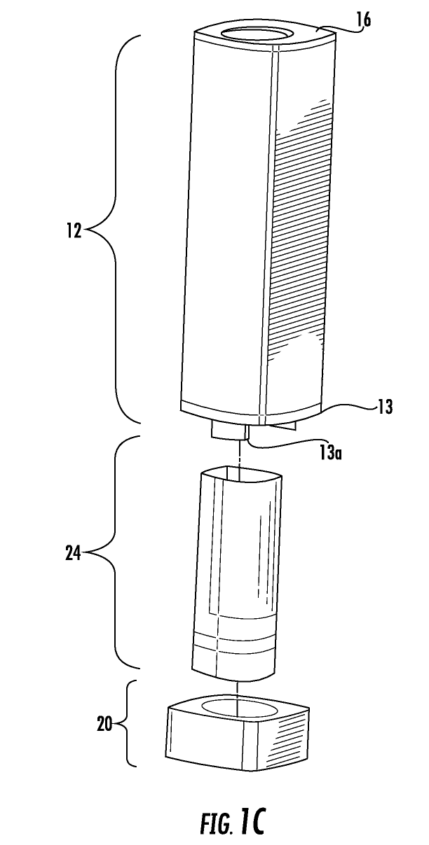

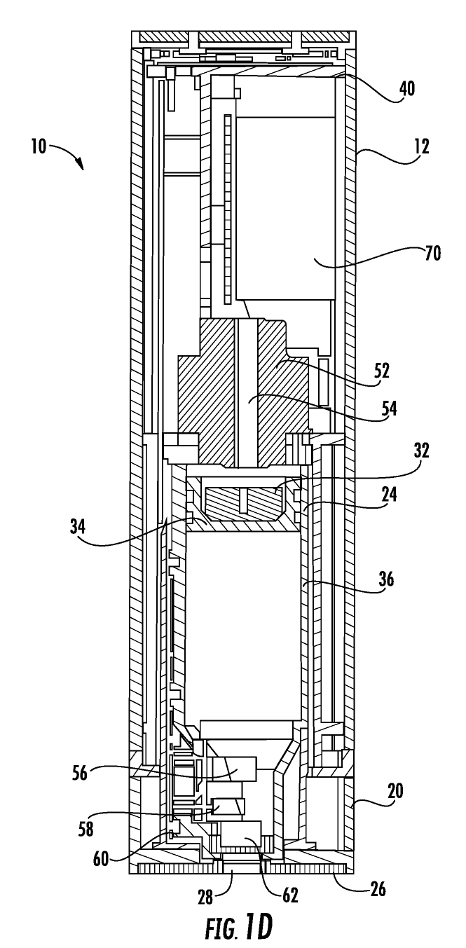

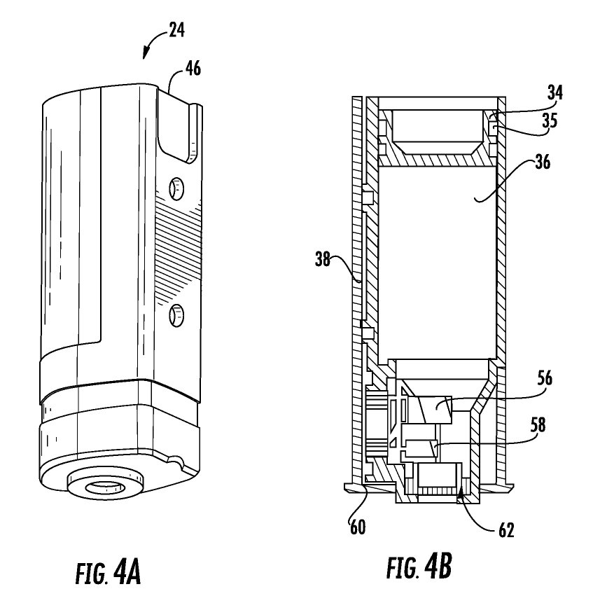

FIG. 1A illustrates a front, top perspective view of the outer housing 12 of the apparatus 10 for dispensing a heated personal lubricant. This outer housing 12, which may be made of aluminum extrusion, matte painted or anodized, provides a user interface and lighting at a top cap 14 of the unit 10. The top cap 14 of the housing has a top plate 16 which retains a clear Lexan® logo lens 18 through which the light of an LED shines upon activation of the unit as described below. FIG. 1A also shows a cartridge cap 20 which attaches to the bottom portion 22 of the housing 12 and retains the disposable cartridge 24 (see FIGS. 4A and 4B) within the housing 12.

FIG. 1B is a rear, bottom perspective view of the outer housing 12. The cartridge cap 20 has a base or bottom plate 26 with a lubricant discharge orifice 28.

FIG. 1C is a front, exploded perspective view which shows the outer housing 12, with connector clip 13, detached from the cartridge cap 20. The removable, disposable cartridge 24 is illustrated between the housing 12 and the cap 20 while it will be understood that the cartridge 24 is normally disposed within the housing 12 and retained therein by the cap 20.

FIG. 1D is a cross-sectional view of an assembled dispenser 10, showing the various components and the geometry of component placement within the outer housing 12. The reference numerals correspond to those used throughout this detailed description section.

Reviewing FIGS. 1A-1D shows that the outer housing 12 houses all electronics for the dispenser unit 10, including the printed circuit board (PCB) controls, the batteries 70, the linear actuator 52 and induction charger 48. The outer housing also provides a connection interface or clip 13 to the cartridge 24. As will be described in detail below, the cartridge 24 utilizes a plunger style unit similar to a tube of caulk (not a gravity feed system), provides connectors for the control system inside the outer housing, contains approximately 0.5 oz. of personal lubricant (preferably coconut oil or the like as is known in the art) in a canister having a small retaining pressure valve 62. The cartridge 24 also contains a heating coil 56 and thermistor 58 to heat the personal lubricant in the canister to a predetermined temperature (range 95° F. to 105° F.). The cartridge 24 is replaceable and disposable.

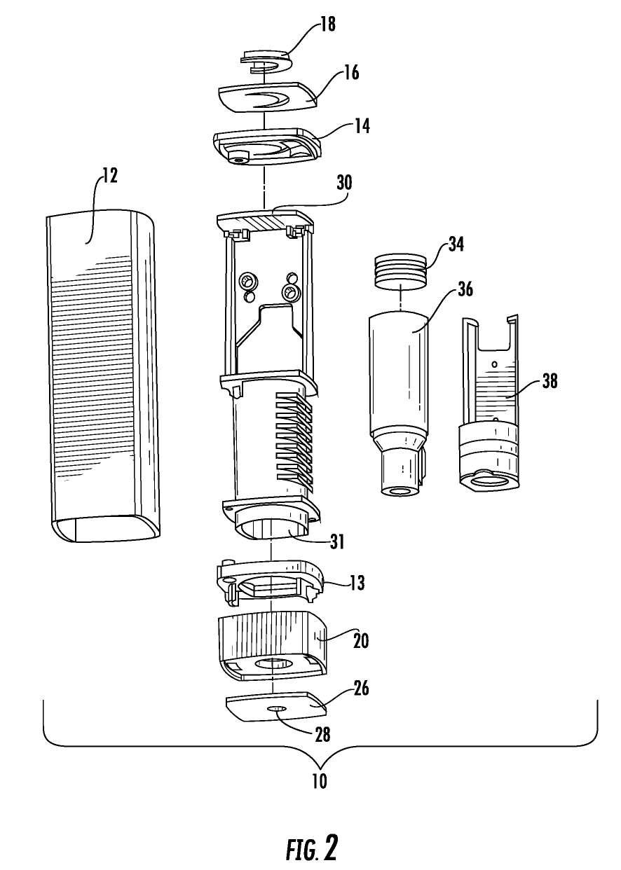

Turning to FIG. 2 various components of the unit 10 are illustrated in a perspective view. An enclosure or outer housing 12 in the shape of a rectangular cylinder is used for housing the various components of the unit 10. A rectangular cylinder is a less common name for a rectangular prism. A prism is a shape made by joining two copies of a base with perpendicular lines. As will be understood further, the various components all fit inside the enclosure 12 presenting a stylish, easy-to-handle unit for dispensing heated personal lubricant. There are no awkward caps to remove or pump levers to work in order to dispense a small amount of heated oil with a single hand. A frame member 30 provides the mounting geometry for the components as will be seen.

The cartridge 24 (see also FIGS. 4A and 4B) which is replaceable and disposable includes the plunger head 32, plunger body 34, pressure canister 36 for housing the lubricant, and the canister cover 38. All of these components are arranged for retention in a cartridge receiving cavity 31 of the frame 30.

FIG. 2 also illustrates the details of a connection interface or clip 13 which attaches to the bottom of frame 30 and is retained on the enclosure cap 20. The cap 20 is provided with a base plate 26 with orifice 28.

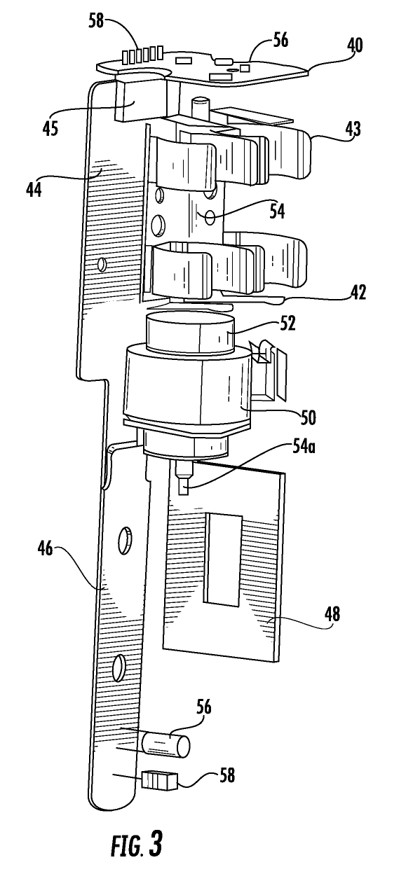

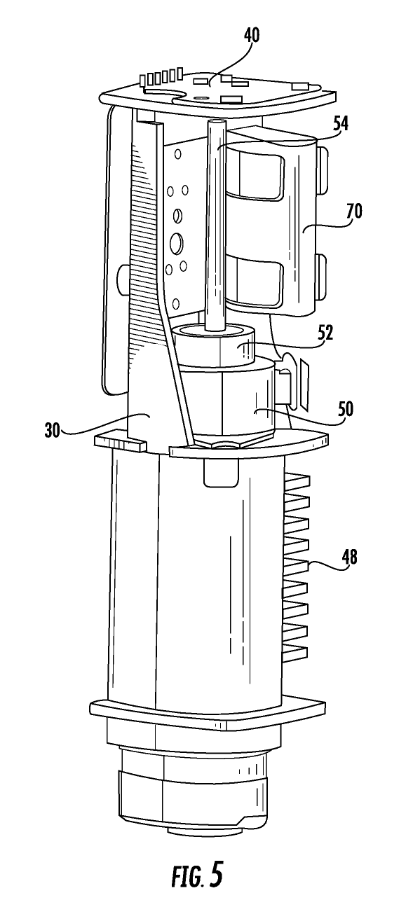

In FIG. 3 can be seen the arrangement of the touch PCB 40, the battery PCB 42, the battery holder 43, the main PCB 44, the microprocessor 45, the canister PCB 46, the induction charging antenna 48, and the stepper motor 50, the linear actuator 52, and drive shaft 54. The touch PCB 40 has an LED 56 for illuminating the logo lens 18 in top plate 16 when a capacitance touch sensor 58 is activated by tapping. The touch PCB 40 is connected to the main PCB 44 which connects all of the PCBs to the battery 70 (FIG. 5) via a plurality of electrical connections.

The main PCB 44 features a microprocessor 45 having heater controls, thermistor controls, induction charger controls and stepper motor controls. FIG. 3 also illustrates a custom heater coil 56 (approx. 1.7 ohm), which will be food contact rated, and a notch coil or wire coil as will be understood by one skilled in the art.

Turning to FIGS. 4A and 4B, the cartridge 24 is shown in bottom perspective (FIG. 4A) and in cross-sectional (FIG. 4B) views. FIG. 4B illustrates the cooperation of the plunger 34 (having o-rings 35) sealed for oil leak prevention. Also seen in FIG. 4B is the heating system (including coil 56 and thermistor 58) of the dispenser which is a part of the cartridge 24 and disposed at the bottom section of the pressure canister 36 and operatively connected to the canister PCB 46. FIG. 4B also illustrates a pressure release valve 62 disposed in the bottom of the canister 36 for retaining oil in the canister until pressurized by the downward urging of the plunger 34.

FIG. 5 depicts the arrangement of various components of the present invention on the frame 30 without showing the outer housing 12. The touch PCB 40 is operatively connected to the main PCB 44, which is connected to the battery PCB 42 and battery 70 (only one shown). The stepper motor 50 drives linear actuator 52 which runs the drive shaft 54 to urge the plunger (not shown in FIG. 5) downwardly to dispense the personal lubricant in the canister out the pressure discharge valve 62 and out orifice 28 in the bottom plate 26 of the enclosure 12.

Also shown in FIG. 5 is the arrangement of the induction charger antenna 48 which wirelessly charges the batteries via the battery PCB 42. The frame 30 has a cartridge cavity 31 (FIG. 2) for retaining the cartridge 24 when inserted into frame 30. Thus, in FIG. 5 it will be understood (while not shown) that plunger 34 is attached to the lower or distal end 54a (FIG. 3) of the drive shaft 54.

The user interface with the dispenser 10 is shown sequentially in FIG. 6. The enclosure 12 and other components are not shown for clarity purposes. The sequence is as follows:

(1) The user touches the logo 18 on the top plate 16 of the unit 10 triggering the capacitance switch on the touch PCB.

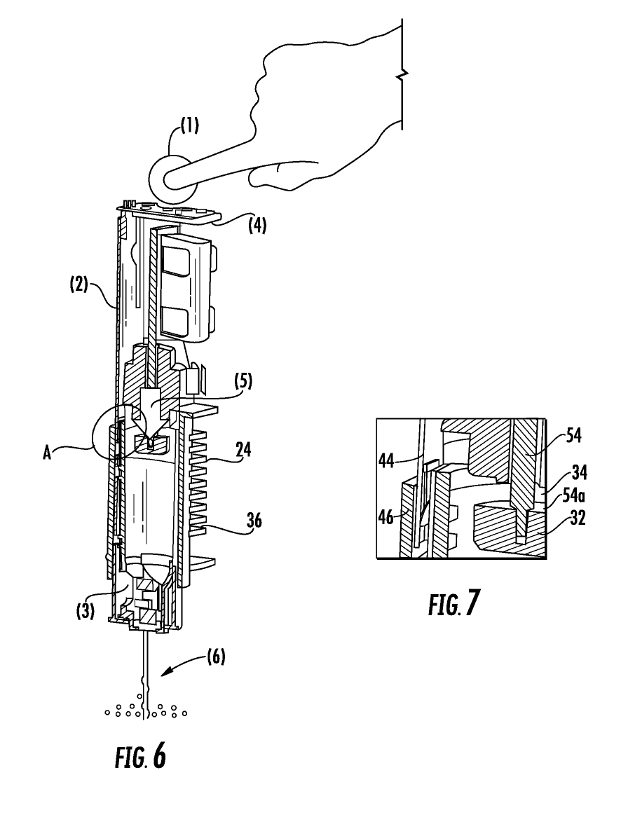

(2) The heating controller in the microprocessor 45 turns on the heating system as the electrical signal is carried through the battery contact (FIG. 7) to the cartridge 24.

(3) The thermistor 58 controls the temperature of the lubricant in the canister 36 and the thermistor signal is transmitted back to the main PCB 44 and the microprocessor 45.

(4) Once the oil (lubricant) reaches a pre-determined temperature in the range of (95° F. to 105° F.), the LED is activated and the light in the logo is on. At this point the user may double tap the logo (the touch switch in the touch PCB) to initiate the discharge of the heated personal lubricant.

(5) The double tap informs the microprocessor to engage the stepper motor 50 to drive the linear actuator and the drive shaft. (6) The plunger 34 is urged downwardly through the canister 36 and approximately 0.05 oz. of warm oil dispenses out the bottom of the unit 10 through pressure valve 62.

FIG. 7 is a detailed view of the battery contact connection from the main PCB 44 to the canister PCB 46.

While this invention has been described in conjunction with the specific embodiments outlined above, it is evident that many alternatives, modifications, and variations will be apparent to those skilled in the art. Accordingly, the embodiments of the invention as set forth above are intended to be illustrative, not limiting. Various changes may be made without departing from the spirit and scope of the invention as defined in the following claims.

1. A system for dispensing a heated personal lubricant comprising:
a dispenser enclosure having a top plate for lighting and activating said system via a touch printed circuit board;
a frame member disposed within said enclosure for mounting system components;
replaceable, remotely chargeable batteries mountable to said frame for providing power to said system and to a battery printed circuit board;
a disposable cartridge removably mountable within a cartridge cavity of said frame, said disposable cartridge retaining therein a canister of said personal lubricant, an internal oil heating system, a dispensing plunger, and a discharge valve, said disposable cartridge having a lower cover to retain a canister printed circuit board and compress an oil O-ring at said canister printed circuit board, said internal oil heating system comprising a heating coil and thermistor operatively connected to said canister printed circuit board and said batteries such that when said canister printed circuit board is activated said personal lubricant is heated;
a stepper motor mountable to said frame for operating a linear actuator, said linear actuator having a drive shaft attached to a top side of said dispensing plunger for urging said plunger downwardly through said canister to dispense said heated personal lubricant from said discharge valve when said stepper motor is actuated;
an induction charger antenna operatively connected to said batteries to wirelessly charge said batteries; and
a main printed circuit board within said enclosure powered by said batteries comprising:
a microprocessor;
a heater controller for controlling said heating coil;
a thermistor controller for controlling said thermistor;
electrical connectors to said touch printed circuit board, said canister printed circuit board, and to said battery printed circuit board;
an induction charger controller; and
a stepper motor controller.
